(19) United States
(12) Patent Application Publication
(10) Pub. No.: US 2025/0113264 A1
(43) Pub. Date: Apr. 3, 2025

(54) DISCOVERY SIGNALING FOR SEAMLESS ROAMING

(71) Applicant: QUALCOMM Incorporated, San Diego, CA (US)

(72) Inventors: Abhishek Pramod PATIL, San Diego, CA (US); Gaurang NAIK, San Diego, CA (US); Sai Yiu Duncan HO, San Diego, CA (US); George CHERIAN, San Diego, CA (US); Alfred ASTERJADHI, San Diego, CA (US); Yanjun SUN, San Diego, CA (US); Abdel Karim AJAMI, San Diego, CA (US)

(21) Appl. No.: 18/480,462

(22) Filed: Oct. 3, 2023

(51) Int. Cl. H04W 36/00; H04W 88/10

(52) U.S. Cl. CPC H04W 36/0069; H04W 36/0033; H04W 88/10

(57) ABSTRACT

This disclosure provides methods, components, devices and systems for discovery signaling for seamless roaming. Some aspects more specifically relate to indicating or advertising information associated with a single mobility domain (SMD) and information associated with access point (AP) devices that support seamless roaming. In some implementations, an AP device or a multi-link device (MLD) may transmit parameters associated with the SMD MLD to advertise information of the SMD MLD. In some implementations, the AP device or MLD may advertise candidate AP devices, which may support the seamless roaming. A non-MLD device, such as a wireless station (STA), may request additional information for a candidate AP device that supports seamless roaming. The AP device may transmit a response to the request indicating a portion of a profile of the candidate AP device.

### TECHNICAL FIELD

This disclosure relates to wireless communication and, more specifically, to discovery signaling for seamless roaming.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a STA may roam from one AP (such as a serving AP) to another AP (such as a target AP) based on various conditions, including (but not limited to) a location of the STA or a signal strength of the target AP. In some implementations, however, the STA may be unable to exchange data with the target AP until the STA obtains context information from the target AP, which may increase the latency associated with roaming operations.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first device. The method may include transmitting an indication of a first set of parameters associated with a single mobility domain (SMD) multi-link device (MLD), where the first set of parameters includes at least an identifier of the SMD MLD and one or more roaming capabilities of the SMD MLD, transmitting an indication of one or more access point (AP) devices affiliated with the SMD MLD for which roaming of a wireless station is supported without reassociation, and facilitating a transfer of context information for the wireless station from a first AP device of the one or more AP devices to a second AP device of the one or more AP devices in accordance with the roaming.

Another innovative aspect of the subject matter described in this disclosure can be implemented in a first device for wireless communications. The first device may include a processing system that includes processor circuitry and memory circuitry that stores code. The processing system may be configured to cause the first device to transmit an indication of a first set of parameters associated with an SMD MLD, where the first set of parameters includes at least an identifier of the SMD MLD and one or more roaming capabilities of the SMD MLD, transmit an indication of one or more AP devices affiliated with the SMD MLD for which roaming of a wireless station is supported without reassociation, and facilitate a transfer of context information for the wireless station from a first AP device of the one or more AP devices to a second AP device of the one or more AP devices in accordance with the roaming.

Another innovative aspect of the subject matter described in this disclosure can be implemented in a first device for wireless communications. The first device may include means for transmitting an indication of a first set of parameters associated with an SMD MLD, where the first set of parameters includes at least an identifier of the SMD MLD and one or more roaming capabilities of the SMD MLD, means for transmitting an indication of one or more AP devices affiliated with the SMD MLD for which roaming of a wireless station is supported without reassociation, and means for facilitating a transfer of context information for the wireless station from a first AP device of the one or more AP devices to a second AP device of the one or more AP devices in accordance with the roaming.

Another innovative aspect of the subject matter described in this disclosure can be implemented in a non-transitory computer-readable medium storing code for wireless communications. The code may include instructions executable by a processor to transmit an indication of a first set of parameters associated with an SMD MLD, where the first set of parameters includes at least an identifier of the SMD MLD and one or more roaming capabilities of the SMD MLD, transmit an indication of one or more AP devices affiliated with the SMD MLD for which roaming of a wireless station is supported without reassociation, and facilitate a transfer of context information for the wireless station from a first AP device of the one or more AP devices to a second AP device of the one or more AP devices in accordance with the roaming.

Another innovative aspect of the subject matter described in this disclosure can be implemented in a method for wireless communications by a second device. The method may include receiving an indication of a first set of parameters associated with an SMD MLD, where the first set of parameters includes at least an identifier of the SMD MLD and one or more roaming capabilities of the SMD MLD, receiving an indication of one or more AP devices affiliated with the SMD MLD for which roaming of a wireless station is supported without reassociation, and facilitating a transfer of context information for the wireless station from a first AP of the one or more AP devices to a second AP device of the one or more AP devices in accordance with the roaming.

Another innovative aspect of the subject matter described in this disclosure can be implemented in a second device for wireless communications. The second device may include a processing system that includes processor circuitry and memory circuitry that stores code. The processing system may be configured to cause the second device to receive an indication of a first set of parameters associated with an SMD MLD, where the first set of parameters includes at least an identifier of the SMD MLD and one or more roaming capabilities of the SMD MLD, receive an indication of one or more AP devices affiliated with the SMD MLD for which roaming of a wireless station is supported without reassociation, and facilitate a transfer of context information for the wireless station from a first AP of the one or more AP devices to a second AP device of the one or more AP devices in accordance with the roaming.

Another innovative aspect of the subject matter described in this disclosure can be implemented in a second device for wireless communications. The second device may include means for receiving an indication of a first set of parameters associated with an SMD MLD, where the first set of parameters includes at least an identifier of the SMD MLD and one or more roaming capabilities of the SMD MLD, means for receiving an indication of one or more AP devices affiliated with the SMD MLD for which roaming of a wireless station is supported without reassociation, and means for facilitating a transfer of context information for the wireless station from a first AP of the one or more AP devices to a second AP device of the one or more AP devices in accordance with the roaming.

Another innovative aspect of the subject matter described in this disclosure can be implemented in a non-transitory computer-readable medium storing code for wireless communications. The code may include instructions executable by a processor to receive an indication of a first set of parameters associated with an SMD MLD, where the first set of parameters includes at least an identifier of the SMD MLD and one or more roaming capabilities of the SMD MLD, receive an indication of one or more AP devices affiliated with the SMD MLD for which roaming of a wireless station is supported without reassociation, and facilitate a transfer of context information for the wireless station from a first AP of the one or more AP devices to a second AP device of the one or more AP devices in accordance with the roaming.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a signaling diagram that supports discovery signaling for seamless roaming.

FIG. 6 shows a process flow that supports discovery signaling for seamless roaming.

FIG. 7 shows a block diagram of an example wireless communication device that supports discovery signaling for seamless roaming.

FIG. 8 shows a block diagram of an example wireless communication device that supports discovery signaling for seamless roaming.

FIG. 9 shows a flowchart illustrating an example process performable by or at a first device that supports discovery signaling for seamless roaming.

FIG. 10 shows a flowchart illustrating an example process performable by or at a second device that supports discovery signaling for seamless roaming.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others.

The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

A WLAN may include one or more access points (APs) and non-AP stations (STAs) that communicate with each other via specific communication links (such as channels within a given frequency band). In some WLANs that support multi-link operations (MLO), a non-AP STA may be affiliated with a non-AP multi-link device (MLD) that operates on multiple communication links. For example, a first STA of the non-AP MLD may operate on a first communication link (such as a 2.4 gigahertz (GHz) channel), while a second STA of the non-AP MLD may operate on a second communication link (such as a 6 GHz channel). Likewise, an AP may be affiliated with (such as controlled or managed by) one or more AP MLDs that operate on more than one communication link. As used herein, the term “STA” may refer to any type of wireless STA, such as a non-AP STA, a non-MLD STA, a non-MLD non-AP STA, or the like. Similarly, the term “AP” may refer to any type of wireless AP, such as an AP MLD or a non-MLD AP, among other examples.

A single mobility domain MLD (SMD MLD) may be a logical entity that operates one or more APs that are affiliated with one or more AP MLDs that are non-collocated. The SMD MLD may present one medium access control (MAC) data service and a single MAC service access point (SAP) to the logical link control (LLC) sublayer. A non-AP that supports seamless roaming may perform association with the SMD MLD which enables the non-AP to seamlessly transition from being served by one set of AP devices to another set of AP devices without performing reassociation. The serving AP set may include non-collocated APs, or AP devices which are affiliated with different AP MLDs.

In some implementations, a STA (such as a non-AP MLD or a non-MLD non-AP STA) may roam from a first AP (such as a serving AP) to a second AP (such as a target AP) based on various conditions, including (but not limited to) a location of the STA, a signal strength of the first AP, a signal strength of the second AP, and so on. To begin exchanging user data with the second AP, however, the STA may have to wait for the first AP to provide the second AP with various user data context parameters, such as an encryption key, a packet number (PN), a sequence number (SN), a block acknowledgement (BA), and a set of encryption keys for the STA, which can introduce latency and signaling overhead.

Various aspects relate generally to discovery signaling for seamless roaming. Some aspects more specifically relate to indicating information associated with a single mobility domain (SMD) and information associated with AP devices that support seamless roaming. In some implementations, an AP device, such as an AP MLD or a non-MLD AP, or an MLD device, such as an MLD SMD, may transmit parameters associated with the SMD MLD to advertise information of the SMD MLD. For example, the MLD may transmit an SMD element in a frame to indicate roaming capabilities of the SMD and an identifier of the SMD MLD. In some implementations, the MLD may include a profile of one or more candidate AP devices, such as MLD AP devices or non-MLD AP devices, in the SMD element. The MLD device may advertise candidate AP devices, which may support the seamless roaming. A non-MLD device, such as a STA, may request additional information for a candidate AP device. For example, the non-MLD device may transmit a message to an AP device to request information of a candidate AP. The AP device may transmit a response to the request for the information indicating at least a portion of the SMD element and at least a portion of a profile of the candidate AP device.

Particular aspects of the subject matter described in this disclosure can be implemented to realize one or more of the following potential advantages. In some implementations, by transmitting or receiving discovery signaling which enables a non-MLD device, such as a STA, to identify an SMD MLD, the described techniques may enable the STA to determine that roaming is supported and identify a candidate AP device as a target AP device for the roaming. The described techniques may enable the STA to perform roaming to (and connect with) the target AP device by using a subset of user data context parameters associated with (such as assigned to) the target AP device. Furthermore, the described techniques can be used for seamless roaming, such that the STA transitions from a serving AP device to a target AP device without performing a reassociation frame exchange with the target AP device.

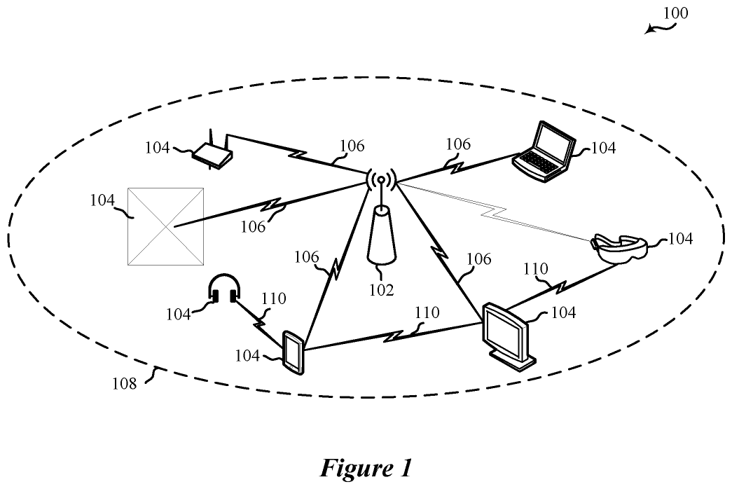

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless AP 102 and any number of STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHz. 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some implementations of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHZ-52.6 GHZ), FR3 (7.125 GHZ-24.25 GHZ), FR4a or FR4-1 (52.6 GHZ-71 GHZ), FR4 (52.6 GHZ-114.25 GHZ), and FR5 (114.25 GHZ-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHZ, 160 MHZ, 240 MHZ, 320 MHZ, 480 MHz, or 640 MHz by bonding together multiple 20 MHz channels.

In some implementations, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (such as High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHZ, 40 MHZ, 80 MHZ, 160 MHz, 240 MHZ, and 320 MHZ. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In implementations in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHZ (and each coupled to a different power amplifier). In some other examples, two transmit chains can be used to support a 240 MHz/160+80 MHz bandwidth mode by puncturing 320 MHz/160+160 MHZ bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some implementations, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

In some implementations, an AP device, such as an AP MLD or a non-MLD AP, or an MLD device, such as an MLD SMD, may transmit parameters associated with the SMD MLD to advertise information of the SMD MLD. For example, the MLD may transmit an SMD element in a frame to indicate roaming capabilities of the SMD and an identifier of the SMD MLD. In some implementations, the MLD may include a profile of one or more candidate AP devices, such as MLD AP devices or non-MLD AP devices, in the SMD element. The MLD device may advertise candidate AP devices, which may support the seamless roaming. A non-MLD device, such as a STA 104, may request additional information for a candidate AP device. For example, the non-MLD device may transmit a message to an AP device to request information of a candidate AP. The AP device may transmit a response to the request for the information indicating at least a portion of the SMD element and at least a portion of a profile of the candidate AP device.

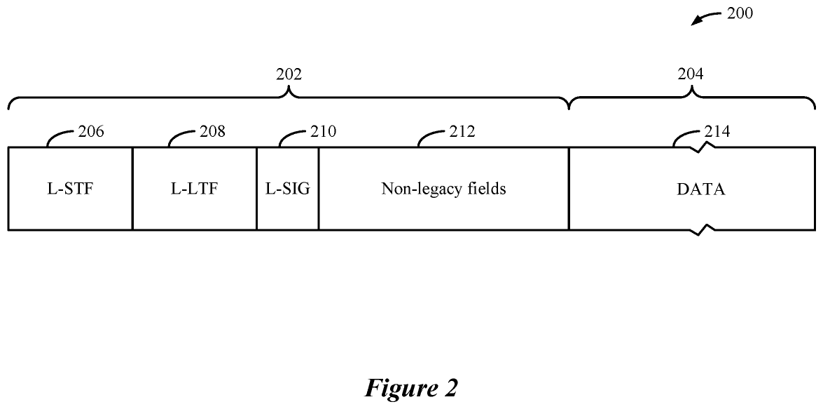

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some implementations, an AP device, such as an AP MLD or a non-MLD AP, or an MLD device, such as an MLD SMD, may transmit parameters associated with the SMD MLD to advertise information of the SMD MLD. For example, the MLD may transmit an SMD element in a frame to indicate roaming capabilities of the SMD and an identifier of the SMD MLD. In some implementations, the MLD may include a profile of one or more candidate AP devices, such as MLD AP devices or non-MLD AP devices, in the SMD element. The MLD device may advertise candidate AP devices, which may support the seamless roaming. A non-MLD device, such as a STA 104, may request additional information for a candidate AP device. For example, the non-MLD device may transmit a message to an AP device to request information of a candidate AP. The AP device may transmit a response to the request for the information indicating at least a portion of the SMD element and at least a portion of a profile of the candidate AP device.

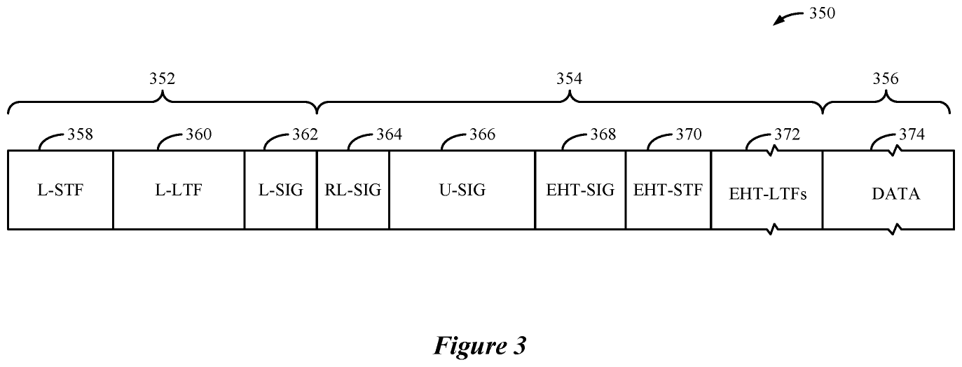

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some implementations, an AP device, such as an AP MLD or a non-MLD AP, or an MLD device, such as an MLD SMD, may transmit parameters associated with the SMD MLD to advertise information of the SMD MLD. For example, the MLD may transmit an SMD element in a frame to indicate roaming capabilities of the SMD and an identifier of the SMD MLD. In some implementations, the MLD may include a profile of one or more candidate AP devices, such as MLD AP devices or non-MLD AP devices, in the SMD element. The MLD device may advertise candidate AP devices, which may support the seamless roaming. A non-MLD device, such as a STA 104, may request additional information for a candidate AP device. For example, the non-MLD device may transmit a message to an AP device to request information of a candidate AP. The AP device may transmit a response to the request for the information indicating at least a portion of the SMD element and at least a portion of a profile of the candidate AP device.

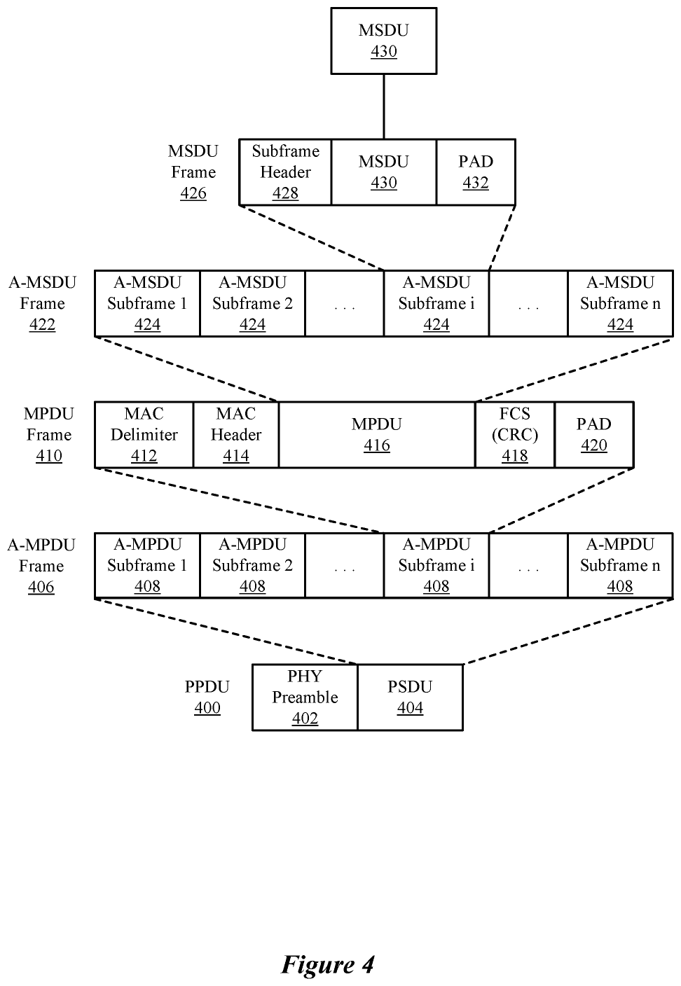

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 contains a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

Some wireless communication devices (including both APs and STAs such as, for example, AP 102 and STAs 104 described with reference to FIG. 1) are capable of MLO. In some implementations, MLO supports establishing multiple different communication links (such as a first link on the 2.4 GHz band, a second link on the 5 GHz band, and the third link on the 6 GHz band) between the STA 104 and the AP 102 and exchanging packets on one or more communications links concurrently and dynamically. Each communication link may support one or more sets of channels or logical entities. In some examples, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as an MLD. An MLD may include a single upper MAC layer, and can include, for example, three independent lower MAC layers and three associated independent PHY layers for respective links in the 2.4 GHZ, 5 GHZ, and 6 GHz bands. This architecture may enable a single association process and security context. An AP MLD may include multiple APs each configured to communicate on a respective communication link with a respective one of multiple STAs 104 of a non-AP MLD (also referred to as a “STA MLD”). The STA MLD may communicate with the AP MLD over one or more of the multiple communication links at a given time. MLDs may independently contend for access on each of the communication links, which achieves latency reduction by enabling the MLD to transmit its packets on the first communication link that becomes available.

Another feature of MLO is Traffic Steering and QoS characterization, which achieves latency reduction and other QoS enhancements by mapping traffic flows having different latency or other requirements to different links. For example, traffic with low latency requirements can be mapped to wireless links operating in the 6 GHZ band and more latency-tolerant flows can be mapped to wireless links operating in the 2.4 GHz or 5 GHz bands.

One type of MLO is alternating multi-link, in which a MLD may listen to two different high performance channels at the same time. When an MLD has traffic to send, it may use the first channel with an access opportunity (such as TXOP). While the MLD may only use one channel to receive or transmit at a time, having access opportunities in two different channels provides low latency when networks are congested.

Another type of MLO is multi-link aggregation (MLA), where traffic associated with a single STA 104 is simultaneously transmitted across multiple communication links in parallel to maximize the utilization of available resources to achieve higher throughput. This is akin to carrier aggregation in the cellular space. That is, during at least some duration of time, transmissions or portions of transmissions may occur over two or more links in parallel at the same time. In some implementations, the parallel wireless communication links may support synchronized transmissions. In some other examples, or during some other durations of time, transmissions over the links may be parallel, but not be synchronized or concurrent. In some implementations or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some implementations, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally, or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some implementations, the exchange of information may occur via a beacon signal, a probe request or probe response, an association request or an association response frame, a dedicated action frame, or an operating mode indicator (OMI), among other examples. In some implementations, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

In some implementations, an AP device, such as an AP MLD or a non-MLD AP, or an MLD device, such as an MLD SMD, may transmit parameters associated with the SMD MLD to advertise information of the SMD MLD. For example, the MLD may transmit an SMD element in a frame to indicate roaming capabilities of the SMD and an identifier of the SMD MLD. In some implementations, the MLD may include a profile of one or more candidate AP devices, such as MLD AP devices or non-MLD AP devices, in the SMD element. The MLD device may advertise candidate AP devices, which may support the seamless roaming. A non-MLD device, such as a STA 104, may request additional information for a candidate AP device. For example, the non-MLD device may transmit a message to an AP device to request information of a candidate AP. The AP device may transmit a response to the request for the information indicating at least a portion of the SMD element and at least a portion of a profile of the candidate AP device.

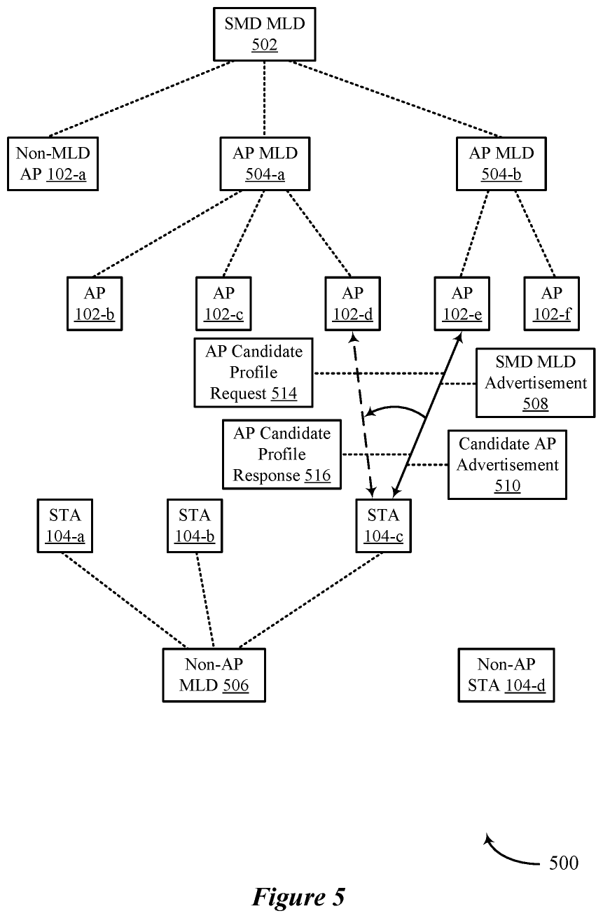

FIG. 5 shows a signaling diagram 500 that supports discovery signaling for seamless roaming. The signaling diagram 500 may implement one or more aspects of the wireless communication network 100. For example, the signaling diagram 500 includes an AP 102-a (such as a non-MLD AP), and AP 102-b (such as an MLD AP), an AP 102-c, an AP 102-d, an AP 102-c, and an AP 102-f, which may be examples of aspects of an AP 102, as shown and described with reference to FIG. 1. Likewise, the signaling diagram 500 includes a STA 104-a (such as a non-AP MLD STA), a STA 104-b, a STA 104-c, and a STA 104-d (such as a non-MLD non-AP STA), which may be examples of a STA 104, as shown and described with reference to FIG. 1.

In some WLANs (such as the wireless communication network 100), when the signal strength of a serving AP (such as the AP 102-e) is weakening, a STA (such as the STA 104-c) may roam to a target AP (such as the AP 102-d) with a better signal quality without waiting for buffered/in-flight DL packets to arrive from the serving AP. Roaming may be useful for upper layer applications that are unaffected by packet loss during roaming, upper layer applications that can handle/process packets delivered out-of-order (between the serving and target APs) during roaming. Roaming also can be used for periodic extended reality (XR) traffic, which may have, for example, a data burst arrival every 16.66 ms. Following a traffic burst, the STA may not expect more traffic until the next burst, so the STA can utilize this gap to roam to a better AP without data interruptions.

As used herein, the term “AP” encompasses both non-MLD APs (such as APs that operate on a single communication link) and AP MLDs 504 that operate on more than one communication link. Likewise, the term “STA” encompasses both non-MLD non-AP STAs (such as STAs that operate on a single communication link) and non-AP MLD that operate on more than one communication link. Thus, in the following description of the signaling diagram 500, when referring to communications between a STA and an AP, the “STA” may be a non-MLD non-AP STA (such as a non-AP STA that is not affiliated with a non-AP MLD, such as the STA 104-d) or an non-AP MLD STA (such as the STA 104-c affiliated with the non-AP MLD 506), and the “AP” may be a non-MLD AP (such as the AP 102-a) or an MLD AP (such as the AP 102-d affiliated with the AP MLD 504-a or the AP 102-e affiliated with the AP MLD 504-b).

In some implementations, there may be a hierarchy between an SMD MLD 502 and AP devices, such as the non-MLD AP 102-a, the AP MLD 504-a, and the AP MLD 504-b. The SMD MLD 502 may have one or more affiliated AP devices, which may be examples of AP MLDs 504 or non-MLD APs 102. If an AP device is affiliated with an AP MLD 504, and the AP MLD 504 is affiliated with the SMD MLD 502, that AP device also may be affiliated with the SMD MLD 502.

EHT devices may use a multi-link information element to advertise muti-link information. There may be several variants of the multi-link information element for specific functionalities. In some implementations, a multi-link control field of the multi-link information element may carry a type indicator corresponding to a functionality of the multi-link information element. For example, a basic multilink information element may be used during discovery and association. The basic multilink information element may provide information pertaining to an MLD and affiliated STAs 104 of the MLD.

Ultra-high reliability (UHR) devices may use a container to provide SMD information, such as information for the SMD MLD 502. The container to carry information of the SMD may be a new element, an extension of a defined multi-link element, a new variant of the multi-link element, or an extension of another element. For example, the signaling diagram may implement a multi-link information element to advertise information of the SMD MLD 502. For example, a multi-link information element may indicate, via the multi-link control field, that the multi-link information element carries information related to the SMD MLD 502. In some implementations, the container carrying information related to the SMD, or the SMD MLD 502, may be referred to as an SMD element.

The SMD element may carry information such as a MAC address of the SMD and roaming capabilities of the SMD. In some implementations, the roaming capabilities of the SMD may include an indication of whether the SMD MLD 502 uses a light backhaul or a heavy backhaul. The indication of the type of backhaul may indicate whether full context transfer for roaming is supported and a time duration associated with gateway switching. In some implementations, information such as the MAC address and the roaming capabilities may be indicated via a common information (“common info”) portion of the SMD element.

In some implementations, the SMD element may include a per-STA profile sub-element. The per-STA profile sub-element may carry information related to candidate AP devices, such as candidate non-MLD APs 102 and candidate AP MLDs 504. The per-STA profile sub-element may assist a client device, such as a STA 104-c, in detecting a candidate for roaming. The per-STA profile sub-element of the SMD element may be conditionally or optionally included with the SMD element. The per-STA profile sub-element may indicate, for each candidate AP device, an AP MAC address, an AP MLD MAC address, an AP MLD identifier, or any combination thereof. In some implementations, the per-STA profile sub-element may indicate a sequence number offset or pseudorandom number space identifier assigned to the candidate AP device.

In some systems, an AP MLD identifier may be locally assigned by a reporting AP MLD. For example, a reporting AP device identifies its affiliated AP MLD 504 with an identifier of ‘0’. If an AP device belongs to multiple BSSID sets, then an AP MLD 504 of an AP device corresponding to a non-transmitted BSSID may be identified by the BSSID index of the non-transmitted BSSID. In some implementations, other AP MLDs 504 may be identified by a unique integer value such that an AP MLD identifier is greater than ‘0’ and less than ‘255’ for a non-multiple BSSID set, and an AP MLD identifier is greater than ‘n−1’ and less than ‘255’. If the reporting AP device does not have information of a reported AP MLD 504, the AP MLD identifier of the reported AP MLD 504 may be set to ‘255’.

In some implementations, an AP device in the signaling diagram 500 may assign AP MLD locally. For example, each AP MLD 504 affiliated with an SMD MLD 502 may assign locally unique AP MLD identifiers to other AP MLDs 504 that are affiliated with the SMD MLD 502. In some other examples, the SMD MLD 502 may designate or assign unique AP MLD identifiers to each AP MLD affiliated with the SMD MLD 502. For example, the SMD MLD 502 may assign a first AP MLD identifier to the AP MLD 504-a and a second AP MLD identifier to the AP MLD 504-b. In some implementations, the AP MLD identifiers of an AP MLD 504 may be used as a collocated set identifier. The collocated set identifier may be used for operations that involve multiple AP MLDs 504 or AP devices affiliated with multiple AP MLDs 504 affiliated with the SMD MLD 502.

In some implementations, an AP MLD 504 affiliated with the SMD MLD 502 may locally assign unique link identifiers for each link of the AP MLD 504. For example, the AP MLD 504-b may assign a first link identifier to a link with AP 102-c and a second link identifier to a link with AP 102-f. An AP device, or a BSS or link, affiliated with the SMD MLD 502 may be uniquely identified via a combination of an AP MLD identifier and a locally assigned link identifier.

AP devices, such as non-MLD APs 102 and AP MLDs 504, affiliated with the SMD MLD 502 may belong to a same ESS. In some implementations, each of the AP devices may be connected to a same distribution system, and the affiliated AP devices may advertise the same SSID.

In some implementations, the SMD element may be included in frames that carry the basic multi-link information element. For example, a beacon frame, a probe response frame, an association frame, a reassociation frame, an association response frame, a reassociation response frame, a multi-link reconfiguration frame, a BSS transition management frame, a management frame, or any combination thereof, may include the SMD element. The management frame may be transmitted to a broadcast address or transmitted to individual devices. In some implementations, the beacon signal may be a beacon frame, a follow-up frame to a beacon frame, or a management frame transmitted to a broadcast address.

In some implementations, a wireless communications system, such as a wireless communication system supporting UHR, may use a follow-up broadcast management frame to a beacon frame to offload the beacon. For example, UHR-specific elements may be carried in the follow-up frame. In some implementations, the SMD element may be carried in the follow-up frame. In some other examples, the basic multi-link information element may include SMD information, such as the SMD element, which may enable STAs which do not support UHR to receive the SMD information. For example, a multi-link information element may be used or extended if SMD information is carried in the follow-up broadcast management frame or when SMD information is carried in individually addressed frames between two UHR devices. The structure of a multi-link information element may include presence indicators and length fields to extend the common information and STA information fields. For example, a multi-link element may include information related to roaming without reassociation or seamless roaming.

In an example, the AP 102-e or the AP MLD 504-b, or both, may transmit an SMD MLD advertisement 508 to the STA 104-c. The SMD MLD advertisement 508 may include, or be an example of, the SMD element. Additionally, or alternatively, the SMD MLD advertisement may be transmitted from one AP device (such as a non-MLD AP 102 or an AP MLD 504) to another AP device (such as another non-MLD AP 102 or another AP MLD 504). In some implementations, the SMD MLD 502 may transmit the SMD MLD advertisement 508 to an AP device.

An AP device also may transmit a candidate AP advertisement 510 to indicate AP devices which are affiliated with the SMD MLD 502 or support seamless roaming, or both. In some implementations, the candidate AP advertisement 510 may be transmitted in, with, or be an example of, a reduced neighbor report or a neighbor report. In some implementations, a bit in a reduced neighbor report or a neighbor report may indicate that a reported AP device is a candidate AP device. In some implementations, a candidate AP device may be referred to as an SMD candidate AP, or a candidate AP device affiliated with the SMD MLD 502. In some implementations, the bit may correspond to a reserved bit in a BSS parameters subfield of the reduced neighbor report or neighbor report. Additionally, or alternatively, one or more bits in an MLD parameters subfield of the reduce neighbor report or neighbor report may indicate whether a reported AP device is an SMD candidate AP device. Additionally, or alternatively, the reduced neighbor report or neighbor report may include dedicated fields for indicating whether a reported AP device is a candidate AP device.

A reported candidate AP device may be a non-MLD AP 102. For example, the reported candidate AP device may not be affiliated with an AP MLD 504. Additionally, or alternatively, the reported candidate AP device may be an AP device that is affiliated with an AP MLD 504. In some implementations, the candidate AP advertisement 510 may not distinguish or differentiate between non-MLD AP devices and MLD AP devices as candidate AP devices. In this example, the MLD parameters subfield may be present, and the AP MLD identifier field may carry a non-zero value. In this example, there may be a single link, and the AP MLD MAC address may be the same as that of the affiliated AP MAC address. In another example, an AP MLD identifier may be assigned to non-MLD AP candidates. The MLD parameters subfield may be present, and the AP MLD identifier, link identifier, and BPCC fields may be set to ‘1’ if the reported AP candidate is a non-MLD AP 102. In some other examples, the absence of the MLD parameters subfield may imply that a reported AP candidate is a non-MLD AP 102.

The candidate AP advertisement 510 may be transmitted to an STA 104, a non-AP MLD 506, or an AP 102-d. A device receiving the candidate AP advertisement may parse the candidate AP advertisement 510 and identify the candidate APs. If the MLD parameters field is present in an entry for a reported candidate AP device, and an SMD candidate AP bit is non-zero, the device may identify whether the reported candidate AP is affiliated with an AP MLD 504 or is a non-MLD AP 102. For example, if the AP MLD identifier field is nonzero and the collocated IP bit is 0 (such as greater than the MBSSID index and less than ‘255’), the reported AP candidate may be a candidate AP device that is affiliated with an AP MLD 504. In some implementations, if the AP MLD identifier is ‘255’ and the collocated AP bit is ‘0’, the reported AP may be a candidate AP device that is a non-MLD AP 102. In some implementations, such as if the candidate AP advertisement 510 does not distinguish between non-MLD AP devices and MLD AP devices, if the AP MLD identifier is non-zero (such as greater than the MBSSID index and less than ‘255’) and the collocated AP bit is ‘0’, the reported candidate AP may be identified as a non-MLD AP 102.

In some implementations, a non-AP device, such as a STA 104 or a non-AP MLD 506, may identify if a candidate AP device is an MLD or affiliated with an MLD based on management frames from a serving AP device. For example, the non-AP device may receive a reduced neighbor report information element or an SMD element in a beacon frame, probe response frame, association response frame, or reassociation response frame. Additionally, or alternatively, the non-AP device may receive an SMD element in a BTM frame or a multi-link reconfiguration frame. The non-AP device may send a probe request directly to a target AP device or receive additional information from the reporting AP device.

For example, if the candidate AP device is an AP MLD 504, the non-AP device may transmit an AP candidate profile request 514 to the candidate AP device. For example, the non-AP device may send a multi-link probe request to the target AP MLD with the transmitter address or BSSID set to an affiliated AP of the target AP MLD. An AP MLD identifier field of the multi-link probe request may be included if the target AP MLD is affiliated with the AP corresponding to the non-transmitted BSSID in a multiple BSSID set and neither the TA nor BSSID is set to the address of the non-transmitted BSSID. The multi-link probe request from the non-AP device may request the information of the AP MLD 504 and the information of all or a subset of APs affiliated with the AP MLD 504. For example, the non-AP device may request information for a subset of affiliated AP devices if the non-AP device supports operations on a subset of bands supported by the target AP MLD. If the candidate is a non-MLD AP 102, the non-AP device may transmit a probe request to the target AP device to request information of the target AP device.

In some implementations, the non-AP device may transmit the AP candidate profile request 514 to a serving AP device. If the candidate AP is an AP MLD 504, the non-AP device may send a multi-link probe request to request information of the AP MLD 504. In some implementations, the multi-link probe request may request information of one or more AP devices affiliated with the AP MLD 504. The AP MLD identifier field may identify the target AP device (such as the AP MLD 504). The link identifier field in the per-STA profile sub-element may identify AP devices to request information for the identified AP devices. In some implementations, the non-AP device may request information for a subset of affiliated AP devices or all affiliated AP devices. For example, an absence of the per-STA profile sub-element may indicate that the non-AP device is requesting information for all affiliated AP devices. A non-AP device may request information of more than one AP MLD 504 affiliated with the SMD MLD 502. If the candidate AP device is a non-MLD ap device, the non-AP MLD may receive information of the target AP device via on-channel tunneling.

An AP device may transmit an AP candidate profile response 516 in response to the AP candidate profile request 514. For example, the AP device may transmit a multi-link probe response including a basic multi-link information element that indicates information of the AP MLD 504 and solicited affiliated AP devices. In some implementations, the multi-link probe response may include at least a portion of parameters of the SMD element, such as information related to the SMD MLD 502 or seamless roaming. The multi-link probe response may be transmitted to a broadcast address. Multiple STAs 104 may receive the multi-link probe response via the broadcast channel to receive the information and reduce a quantity of multi-link probe request transmissions. If more than one basic multi-link information elements or SMD elements are carried in a same frame, the AP MLD identifier may identify the reported AP MLD. For example, an absence of an AP MLD identifier in a multi-link probe response may indicate that the basic multi-link information element corresponds to the transmitting AP's AP MLD.

In some implementations, profiles for each requested candidate AP device may include a large amount of information. In some implementations, a field in a basic multi-link information element or a field in an SMD element may indicate that the information element is carrying partial information. For example, the element may not include complete information for the contents of the common info field or a per-STA profile sub-element, or both.

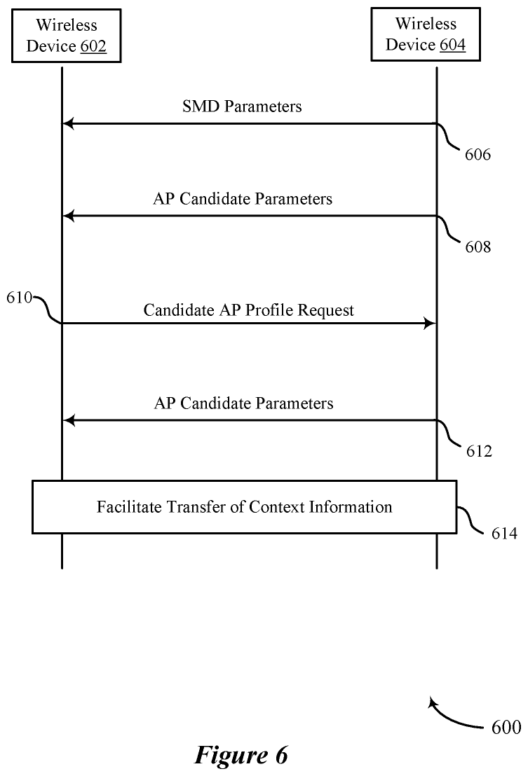

FIG. 6 shows an example of a process flow 600 that supports discovery signaling for seamless roaming. The process flow 600 may implement one or more aspects of the wireless communication network 100 or the signaling diagram 500, as shown and described with reference to FIGS. 1 and 5. For example, the process flow 600 includes a wireless device 602 and a wireless device 604 which may communicate with each other via one or more communication links 106. The wireless device 602 may be an example of a non-AP device, such as a STA 104 or a non-AP MLD 506, or an AP device, such as a non-MLD AP 102 or an AP MLD 504. The wireless device 604 may be an example of an AP device, such as a non-MLD AP 102 or an AP MLD 504, or an SMD MLD 502.

At 606, the wireless device 604 may transmit an indication of a first set of parameters associated with an SMD MLD (such as an SMD MLD 502). In some implementations, the wireless device 604 may transmit an SMD MLD advertisement which may include, for example, an SMD element. The first set of parameters may include at least an identifier of the SMD MLD and one or more roaming capabilities of the SMD MLD. In some implementations, the identifier of the SMD MLD is a MAC address associated with the SMD MLD. In some implementations, the one or more roaming capabilities may include a backhaul capability of the SMD MLD. The wireless device 604 may transmit the indication of the first set of parameters via a management frame, a beacon signal, a probe request, a probe response, an associated request, a reassociation request, or a response frame, a multi-link reconfiguration message, a basic service set transition management message, or any combination thereof. In some implementations, the wireless device 604 may transmit the management frame to a broadcast address or to an address of an individual device, such as the wireless device 602.

At 608, the wireless device 604 may transmit an indication of one or more AP devices affiliated with the SMD MLD for which roaming of a STA is supported without reassociation. For example, the wireless device 604 may transmit a candidate AP advertisement to indicate information of AP devices which support seamless roaming. In some implementations, the wireless device 604 may transmit a reduced neighbor report element, a neighbor report element, a multi-link element, or any combination thereof, including the indication of the one or more AP devices affiliated with the SMD MLD. In some implementations, the indication of the one or more AP devices includes a basic service set parameter field and an MLD parameters subfield for each AP device of the one or more AP devices. In some implementations, the indication of the one or more AP devices indicates whether each AP device of the one or more AP devices is an MLD AP or a non-MLD AP.

At 610, the wireless device 602 may transmit a request for information associated with an AP device of the one or more AP devices. For example, the wireless device 602 may request an AP candidate profile for one or more candidate AP devices. In some implementations, the request for information of an AP device may include an identifier of the AP device, a transmitter address of the AP device, a BSSID associated with the AP device, a BSS color associated with a BS of the AP device, or any combination thereof.

At 612, the wireless device 604 may transmit a message in response to the request for information associated with the AP device of the one or more AP devices. For example, the wireless device 604 may transmit an AP candidate profile response. The message may include at least a first portion of the first set of parameters associated with the SMD MLD and at least a second portion of a second set of parameters associated with the AP device. For example, the wireless device 604 may transmit a message including the SMD element, or a portion of the SMD element, and at least a portion of a profile of the AP device. In some implementations, the wireless device 604 may transmit the message to a broadcast channel.

At 614, the wireless device 602 or the wireless device 604, or both, may facilitate a transfer of context information for the STA from a first AP device of the one or more AP devices to a second AP device of the one or more AP devices in accordance with the roaming. In some examples, facilitating the transfer of context information for the STA may include transferring the STA from being served by the first AP device to the second AP device. For example, the wireless device 602 may be a STA 104, and the STA 104 may seamlessly roam from the first AP device to the second AP device. The wireless device 604 may be the first AP (e.g., a serving AP, a source AP of the roaming) for the STA, and the wireless device 604 may facilitate the transfer of the context information for the wireless device 602 to a the second AP device (e.g., a target AP of the roaming).

For seamless roaming, the first AP device, or the serving AP device, may indicate at least a portion of context information associated with a non-AP MLD or wireless device to one or more candidate AP devices. In some examples, the serving AP device may indicate the context information to the one or more candidate AP devices via a backhaul link, such as a wired ethernet link or a wireless backhaul link, or via over-the-air signaling, such as AP-to-AP communications. If the serving AP device indicates the context information via a backhaul link, the serving AP device may send the context information through multiple devices, such network switches or controllers. The second AP device may acquire, such as from the first AP device, the non-AP MLD, or the SMD MLD, the context information or parameters to perform wireless communications with the STA. The wireless device 602 may facilitate the transfer of the context information by initiating communications (e.g., the transmission or reception of one or more wireless frames) with the second AP device in accordance with the transferred context information. Some examples of context information may include encryption keys, user data context parameters, one or more PNs for the STA, one or more SNs for the STA, one or more BAs, or any combination thereof. In some examples, the wireless device 604 may facilitate the transfer of the context information by transmitting all or a portion of the context information to the second AP device, or to an intermediate device (e.g., a non-AP MLD, an SMD MLD) that shares the context information with the second AP device.

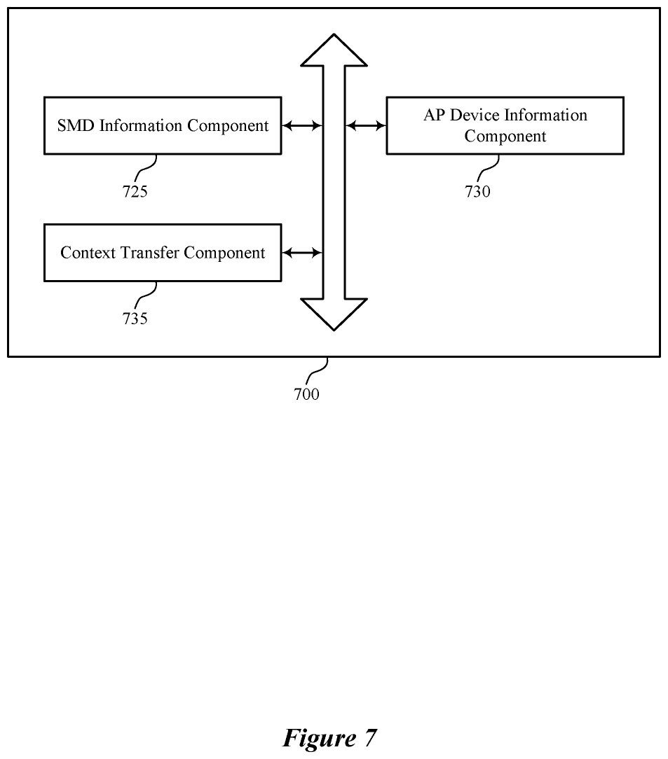

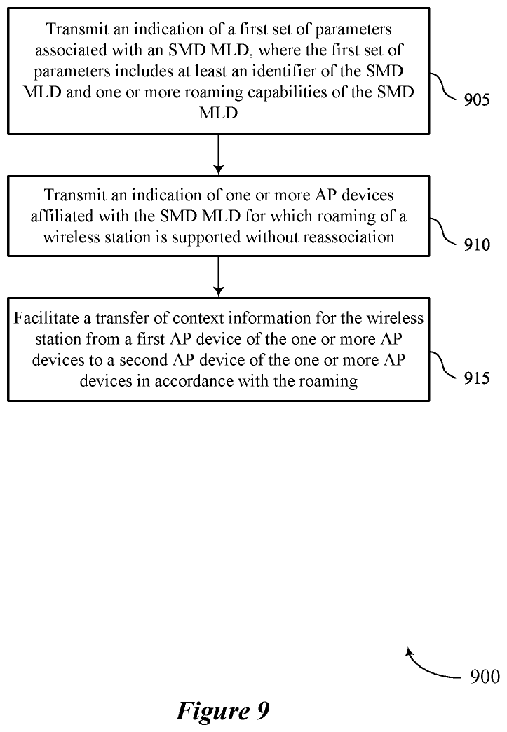

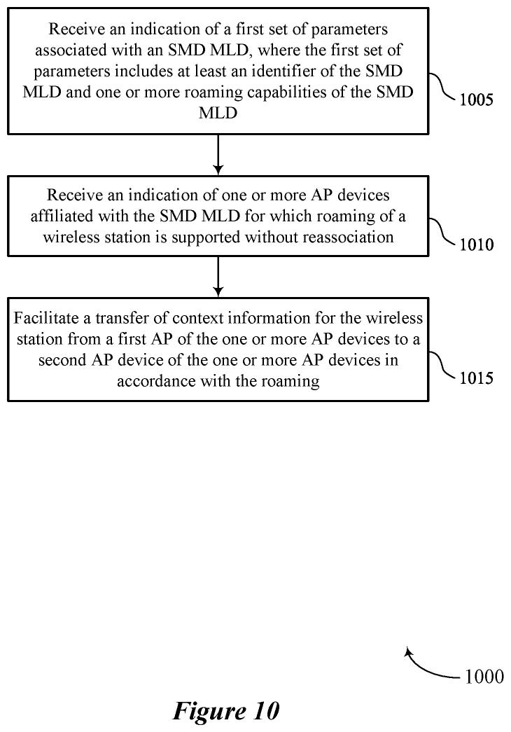

FIG. 7 shows a block diagram of an example wireless communication device 700 that supports discovery signaling for seamless roaming. In some implementations, the wireless communication device 700 is configured to perform the processes 900 and 1000 described with reference to FIGS. 9 and 10, respectively. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 700 can configurable or configured for use in an AP, such as the AP 102 described with reference to FIG. 1. In some other examples, the wireless communication device 700 can be an AP that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some implementations, the wireless communication device 700 also includes or can be coupled with one or more application processors which may be further coupled with one or more other memories. In some implementations, the wireless communication device 700 further includes at least one external network interface coupled with the processing system that enables communication with a core network or backhaul network that enables the wireless communication device 700 to gain access to external networks including the Internet.

The wireless communication device 700 includes an SMD information component 725, an AP device information component 730, and a context transfer component 735. Portions of one or more of the SMD information component 725, the AP device information component 730, and the context transfer component 735 may be implemented at least in part in hardware or firmware. For example, one or more of the SMD information component 725, the AP device information component 730, and the context transfer component 735 may be implemented at least in part by at least a processor or a modem. In some implementations, portions of one or more of the SMD information component 725, the AP device information component 730, and the context transfer component 735 may be implemented at least in part by a processor and software in the form of processor-executable code stored in memory.

The wireless communication device 700 may support wireless communications in accordance with examples as disclosed herein. The SMD information component 725 is configurable or configured to transmit an indication of a first set of parameters associated with an SMD MLD, where the first set of parameters includes at least an identifier of the SMD MLD and one or more roaming capabilities of the SMD MLD. The AP device information component 730 is configurable or configured to transmit an indication of one or more AP devices affiliated with the SMD MLD for which roaming of a STA is supported without reassociation. The context transfer component 735 is configurable or configured to facilitate a transfer of context information for the STA from a first AP device of the one or more AP devices to a second AP device of the one or more AP devices in accordance with the roaming.

In some implementations, the AP device information component 730 is configurable or configured to receive a request for information associated with an AP device of the one or more AP devices based on transmitting the indication of the one or more AP devices.

In some implementations, the AP device information component 730 is configurable or configured to transmit, in response to the request for information associated with the AP device, a message indicating at least a first portion of the first set of parameters associated with the SMD MLD and at least a second portion of a second set of parameters associated with the AP device.

In some implementations, to support transmitting the indication of the one or more AP devices, the AP device information component 730 is configurable or configured to transmit, to a broadcast address, the message including at least the first portion of the first set of parameters and at least the second portion of the second set of parameters.

In some implementations, the second set of parameters includes one or more link identifiers of links established with the AP device an identifier of the AP device, a MAC address of the AP device, or any combination thereof.

In some implementations, the request for information associate with the AP device includes an identifier of the AP device, a transmitter address of the AP device, a basic service set identifier associated with the AP device, a basic service set color associated with a basic service set of the AP device, or any combination thereof.

In some implementations, the request correspond to all AP devices of the one or more AP devices or a subset of AP devices of the one or more AP devices.

In some implementations, the one or more roam capabilities of the SMD MLD include a backhaul capability of the SMD MLD.

In some implementations, to support transmitting the indication of the first set of parameters, the SMD information component 725 is configurable or configured to transmit a management frame, a beacon signal, a probe request, a probe response, an associated request, a reassociation request, or a response frame, a multi-link reconfiguration message, a basic service set transition management message, or any combination thereof, including the indication of the first set of parameters associated with the SMD MLD.

In some implementations, to support transmitting the indication of the first set of parameters, the AP device information component 730 is configurable or configured to transmit an indication of a profile for each AP device of the one or more AP devices affiliated with the SMD MLD.

In some implementations, a profile for an AP device of the one or more AP devices affiliate with the SMD MLD includes a Media Access Control address associated with the AP device, an identifier associated with the AP device, one or more AP MLD identifiers, one or more link identifiers of links established with the AP device, a service set identifier associated with the SMD MLD, or any combination thereof.

In some implementations, the identifier associate with the AP device is assigned by an MLD AP device, by the SMD MLD, or by a centralized controller.

In some implementations, the AP device information component 730 is configurable or configured to receive, from the AP device, an indication of the one or more link identifiers of the links established by the AP device.

In some implementations, to support transmitting the indication of the one or more AP devices, the AP device information component 730 is configurable or configured to transmit a reduced neighbor report element, a neighbor report element, or a multi-link element, or any combination thereof, including the indication of the one or more AP devices affiliated with the SMD MLD.

In some implementations, the indication of the one or more AP devices include a basic service set parameters subfield and an MLD parameters subfield for each AP device of the one or more AP devices.

In some implementations, the indication of the one or more AP devices indicate whether each AP device of the one or more AP devices is an MLD AP or a non-MLD AP.

In some implementations, the identifier of the SMD MLD may be a MAC address associated with the SMD MLD.

In some implementations, the context information includes one or more encryption keys associated with the wireless station, one or more pseudorandom numbers associated with the wireless station, one or more sequence numbers associated with the wireless station, one or more block acknowledgments associated with the wireless station, or any combination thereof

Additionally, or alternatively, the wireless communication device 700 may support wireless communications in accordance with examples as disclosed herein. In some implementations, the SMD information component 725 is configurable or configured to receive an indication of a first set of parameters associated with an SMD MLD, where the first set of parameters includes at least an identifier of the SMD MLD and one or more roaming capabilities of the SMD MLD. In some implementations, the AP device information component 730 is configurable or configured to receive an indication of one or more AP devices affiliated with the SMD MLD for which roaming of a STA is supported without reassociation. In some implementations, the context transfer component 735 is configurable or configured to facilitate a transfer of context information for the STA from a first AP of the one or more AP devices to a second AP device of the one or more AP devices in accordance with the roaming.

In some implementations, the AP device information component 730 is configurable or configured to transmit a request for information associated with an AP device of the one or more AP devices based on transmitting the indication of the one or more AP devices.

In some implementations, the AP device information component 730 is configurable or configured to receive, in response to the request for information associated with the AP device, a message indicating at least a first portion of the first set of parameters associated with the SMD MLD and at least a second portion of a second set of parameters associated with the AP device.

In some implementations, to support receiving the indication of the one or more AP devices, the AP device information component 730 is configurable or configured to receive, via a broadcast address, the message including at least the first portion of the first set of parameters and at least the second portion of the second set of parameters.

In some implementations, the request for information associate with the AP device includes an identifier of the AP device, a transmitter address of the AP device, a basic service set identifier associated with the AP device, a basic service set color associated with a basic service set of the AP device, or any combination thereof.

In some implementations, the one or more roam capabilities of the SMD MLD include a backhaul capability of the SMD MLD.

In some implementations, to support receiving the indication of the first set of parameters, the SMD information component 725 is configurable or configured to receive a management frame, a beacon signal, a probe request, a probe response, an associated request, a reassociation request, or a response frame, a multi-link reconfiguration message, a basic service set transition management message, or any combination thereof, including the indication of the first set of parameters associated with the SMD MLD.

In some implementations, to support receiving the indication of the first set of parameters, the AP device information component 730 is configurable or configured to receive an indication of a profile for each AP device of the one or more AP devices affiliated with the SMD MLD.

In some implementations, a profile for an AP device of the one or more AP devices affiliate with the SMD MLD includes a Media Access Control address associated with the AP device, an identifier associated with the AP device, one or more AP MLD identifiers, one or more link identifiers of links established with the AP device, a service set identifier associated with the SMD MLD, or any combination thereof.

In some implementations, the identifier associate with the AP device is assigned by an MLD AP device, by the SMD MLD, or by a centralized controller.

In some implementations, to support transmitting the indication of the one or more AP devices, the AP device information component 730 is configurable or configured to receive a reduced neighbor report element, neighbor report element, or a multi-link element, or any combination thereof, including the indication of the one or more APs affiliated with the SMD MLD.

In some implementations, the indication of the one or more AP devices include a basic service set parameters subfield and an MLD parameters subfield for each AP device of the one or more AP devices.

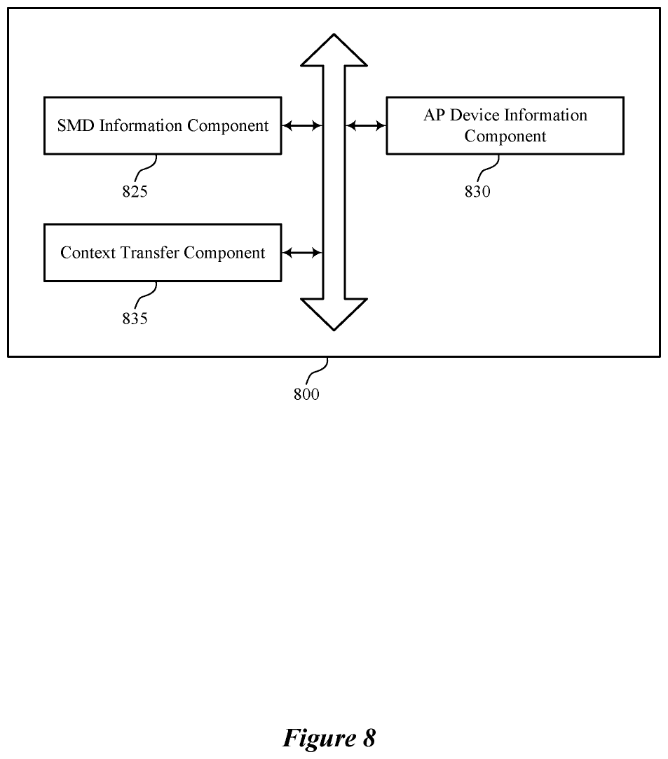

FIG. 8 shows a block diagram of an example wireless communication device 800 that supports discovery signaling for seamless roaming. In some implementations, the wireless communication device 800 is configured to perform the process 1000 described with reference to FIG. 10. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 800 can configurable or configured for use in a STA, such as the STA 104 described with reference to FIG. 1. In some other examples, the wireless communication device 800 can be a STA that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some implementations, the wireless communication device 800 also includes or can be coupled with one or more application processors which may be further coupled with one or more other memories. In some implementations, the wireless communication device 800 further includes a user interface (UI) (such as a touchscreen or keypad) and a display, which may be integrated with the UI to form a touchscreen display that is coupled with the processing system. In some implementations, the wireless communication device 800 may further include one or more sensors such as, for example, one or more inertial sensors, accelerometers, temperature sensors, pressure sensors, or altitude sensors, that are coupled with the processing system.

The wireless communication device 800 includes an SMD information component 825, an AP device information component 830, and a context transfer component 835. Portions of one or more of the SMD information component 825, the AP device information component 830, and the context transfer component 835 may be implemented at least in part in hardware or firmware. For example, one or more of the SMD information component 825, the AP device information component 830, and the context transfer component 835 may be implemented at least in part by at least a processor or a modem. In some implementations, portions of one or more of the SMD information component 825, the AP device information component 830, and the context transfer component 835 may be implemented at least in part by a processor and software in the form of processor-executable code stored in memory.

The wireless communication device 800 may support wireless communications in accordance with examples as disclosed herein. The SMD information component 825 is configurable or configured to receive an indication of a first set of parameters associated with an SMD MLD, where the first set of parameters includes at least an identifier of the SMD MLD and one or more roaming capabilities of the SMD MLD. The AP device information component 830 is configurable or configured to receive an indication of one or more AP devices affiliated with the SMD MLD for which roaming of a STA is supported without reassociation. The context transfer component 835 is configurable or configured to facilitate a transfer of context information for the STA from a first AP of the one or more AP devices to a second AP device of the one or more AP devices in accordance with the roaming.

In some implementations, the AP device information component 830 is configurable or configured to transmit a request for information associated with an AP device of the one or more AP devices based on transmitting the indication of the one or more AP devices.

In some implementations, the AP device information component 830 is configurable or configured to receive, in response to the request for information associated with the AP device, a message indicating at least a first portion of the first set of parameters associated with the SMD MLD and at least a second portion of a second set of parameters associated with the AP device.

In some implementations, to support receiving the indication of the one or more AP devices, the AP device information component 830 is configurable or configured to receive, via a broadcast address, the message including at least the first portion of the first set of parameters and at least the second portion of the second set of parameters.

In some implementations, the request for information associate with the AP device includes an identifier of the AP device, a transmitter address of the AP device, a basic service set identifier associated with the AP device, a basic service set color associated with a basic service set of the AP device, or any combination thereof.

In some implementations, the one or more roam capabilities of the SMD MLD include a backhaul capability of the SMD MLD.

In some implementations, to support receiving the indication of the first set of parameters, the SMD information component 825 is configurable or configured to receive a management frame, a beacon signal, a probe request, a probe response, an associated request, a reassociation request, or a response frame, a multi-link reconfiguration message, a basic service set transition management message, or any combination thereof, including the indication of the first set of parameters associated with the SMD MLD.

In some implementations, to support receiving the indication of the first set of parameters, the AP device information component 830 is configurable or configured to receive an indication of a profile for each AP device of the one or more AP devices affiliated with the SMD MLD.

In some implementations, a profile for an AP device of the one or more AP devices affiliate with the SMD MLD includes a Media Access Control address associated with the AP device, an identifier associated with the AP device, one or more AP MLD identifiers, one or more link identifiers of links established with the AP device, a service set identifier associated with the SMD MLD, or any combination thereof.

In some implementations, the identifier associate with the AP device is assigned by an MLD AP device, by the SMD MLD, or by a centralized controller.

In some implementations, to support transmitting the indication of the one or more AP devices, the AP device information component 830 is configurable or configured to receive a reduced neighbor report element, neighbor report element, or a multi-link element, or any combination thereof, including the indication of the one or more APs affiliated with the SMD MLD.

In some implementations, the indication of the one or more AP devices include a basic service set parameters subfield and an MLD parameters subfield for each AP device of the one or more AP devices.

FIG. 9 shows a flowchart illustrating an example process 900 performable by or at a first device that supports discovery signaling for seamless roaming. The operations of the process 900 may be implemented by a first device or its components as described herein. For example, the process 900 may be performed by a wireless communication device, such as the wireless communication device 700 described with reference to FIG. 7, operating as or within a wireless AP. In some implementations, the process 900 may be performed by a wireless AP, such as one of the APs 102 described with reference to FIG. 1.

In some implementations, in block 905, the first device may transmit an indication of a first set of parameters associated with an SMD MLD, where the first set of parameters includes at least an identifier of the SMD MLD and one or more roaming capabilities of the SMD MLD. The operations of block 905 may be performed in accordance with examples as disclosed herein. In some implementations, aspects of the operations of block 905 may be performed by an SMD information component 725 as described with reference to FIG. 7.

In some implementations, in block 910, the first device may transmit an indication of one or more AP devices affiliated with the SMD MLD for which roaming of a STA is supported without reassociation. The operations of block 910 may be performed in accordance with examples as disclosed herein. In some implementations, aspects of the operations of block 910 may be performed by an AP device information component 730 as described with reference to FIG. 7.

In some implementations, in block 915, the first device may facilitate a transfer of context information for the STA from a first AP device of the one or more AP devices to a second AP device of the one or more AP devices in accordance with the roaming. The operations of block 915 may be performed in accordance with examples as disclosed herein. In some implementations, aspects of the operations of block 915 may be performed by a context transfer component 735 as described with reference to FIG. 7.

FIG. 10 shows a flowchart illustrating an example process 1000 performable by or at a second device that supports discovery signaling for seamless roaming. The operations of the process 1000 may be implemented by a second device or its components as described herein. For example, the process 1000 may be performed by a wireless communication device, such as the wireless communication device 700 described with reference to FIG. 7, operating as or within a wireless AP or a wireless STA. In some implementations, the process 1000 may be performed by a wireless AP or a wireless STA, such as one of the APs 102 or the STAs 104 described with reference to FIG. 1.

In some implementations, in block 1005, the second device may receive an indication of a first set of parameters associated with an SMD MLD, where the first set of parameters includes at least an identifier of the SMD MLD and one or more roaming capabilities of the SMD MLD. The operations of block 1005 may be performed in accordance with examples as disclosed herein. In some implementations, aspects of the operations of block 1005 may be performed by an SMD information component 725 or an SMD information component 825 as described with reference to FIGS. 7 and 8.

In some implementations, in block 1010, the second device may receive an indication of one or more AP devices affiliated with the SMD MLD for which roaming of a STA is supported without reassociation. The operations of block 1010 may be performed in accordance with examples as disclosed herein. In some implementations, aspects of the operations of block 1010 may be performed by an AP device information component 730 or an AP device information component 830 as described with reference to FIGS. 7 and 8.

In some implementations, in block 1015, the second device may facilitate a transfer of context information for the STA from a first AP of the one or more AP devices to a second AP device of the one or more AP devices in accordance with the roaming. The operations of block 1015 may be performed in accordance with examples as disclosed herein. In some implementations, aspects of the operations of block 1015 may be performed by a context transfer component 735 or a context transfer component 835 as described with reference to FIGS. 7 and 8.

Implementation examples are described in the following numbered clauses:

The following provides an overview of aspects of the present disclosure:

Aspect 1: A method for wireless communications at a first device, including: transmitting an indication of a first set of parameters associated with an SMD MLD, where the first set of parameters includes at least an identifier of the SMD MLD and one or more roaming capabilities of the SMD MLD; transmitting an indication of one or more AP devices affiliated with the SMD MLD for which roaming of a wireless station is supported without reassociation; and facilitating a transfer of context information for the wireless station from a first AP device of the one or more AP devices to a second AP device of the one or more AP devices in accordance with the roaming.

Aspect 2: The method of aspect 1, further including: receiving a request for information associated with an AP device of the one or more AP devices based at least in part on transmitting the indication of the one or more AP devices.

Aspect 3: The method of aspect 2, further including: transmitting, in response to the request for information associated with the AP, a message indicating at least a first portion of the first set of parameters associated with the SMD MLD and at least a second portion of a second set of parameters associated with the AP device.

Aspect 4: The method of aspect 3, where transmitting the indication of the one or more AP devices includes: transmitting, to a broadcast address, the message including at least the first portion of the first set of parameters and at least the second portion of the second set of parameters.

Aspect 5: The method of any of aspects 3 through 4, where the second set of parameters includes one or more link identifiers of links established with the AP device an identifier of the AP device, a MAC address of the AP device, or any combination thereof.

Aspect 6: The method of any of aspects 2 through 5, where the request for information associated with the AP device includes an identifier of the AP device, a transmitter address of the AP device, a basic service set identifier associated with the AP device, a basic service set color associated with a basic service set of the AP device, or any combination thereof.

Aspect 7: The method of any of aspects 2 through 6, where the request corresponds to all AP devices of the one or more AP devices or a subset of AP devices of the one or more AP devices.

Aspect 8: The method of any of aspects 1 through 7, where the one or more roaming capabilities of the SMD MLD include a backhaul capability of the SMD MLD.

Aspect 9: The method of any of aspects 1 through 8, where transmitting the indication of the first set of parameters includes: transmitting a management frame, a beacon signal, a probe request, a probe response, an associated request, a reassociation request, or a response frame, a multi-link reconfiguration message, a basic service set transition management message, or any combination thereof, including the indication of the first set of parameters associated with the SMD MLD.

Aspect 10: The method of any of aspects 1 through 9, where transmitting the indication of the first set of parameters includes: transmitting an indication of a profile for each AP device of the one or more AP devices affiliated with the SMD MLD.

Aspect 11: The method of aspect 10, where a profile for an AP device of the one or more AP devices affiliated with the SMD MLD includes a MAC address associated with the AP device, an identifier associated with the AP device, one or more AP MLD identifiers, one or more link identifiers of links established with the AP device, a service set identifier associated with the SMD MLD, or any combination thereof.

Aspect 12: The method of aspect 11, where the identifier associated with the AP device is assigned by an MLD AP device, by the SMD MLD, or by a centralized controller.

Aspect 13: The method of any of aspects 11 through 12, further including: receiving, from the AP device, an indication of the one or more link identifiers of the links established by the AP device.

Aspect 14: The method of any of aspects 1 through 13, where transmitting the indication of the one or more AP devices includes: transmitting a reduced neighbor report element, a neighbor report element, or a multi-link element, or any combination thereof, including the indication of the one or more AP devices affiliated with the SMD MLD.

Aspect 15: The method of any of aspects 1 through 14, where the indication of the one or more AP devices includes a basic service set parameters subfield and an MLD parameters subfield for each AP device of the one or more AP devices.

Aspect 16: The method of any of aspects 1 through 15, where the indication of the one or more AP devices indicates whether each AP device of the one or more AP devices is an MLD AP or a non-MLD AP.

Aspect 17: The method of any of aspects 1 through 16, where the identifier of the SMD MLD is a MAC address associated with the SMD MLD.

Aspect 18: The method of any of aspects 1 through 17, where the context information includes one or more encryption keys associated with the wireless station, one or more pseudorandom numbers associated with the wireless station, one or more sequence numbers associated with the wireless station, one or more block acknowledgments associated with the wireless station, or any combination thereof.

Aspect 19: A method for wireless communications at a second device, including: receiving an indication of a first set of parameters associated with a SMD MLD, where the first set of parameters includes at least an identifier of the SMD MLD and one or more roaming capabilities of the SMD MLD; receiving an indication of one or more AP devices affiliated with the SMD MLD for which roaming of a wireless station is supported without reassociation; and facilitating a transfer of context information for the wireless station from a first AP of the one or more AP devices to a second AP device of the one or more AP devices in accordance with the roaming.

Aspect 20: The method of aspect 19, further including: transmitting a request for information associated with an AP device of the one or more AP devices based at least in part on transmitting the indication of the one or more AP devices.

Aspect 21: The method of aspect 20, further including: receiving, in response to the request for information associated with the AP device, a message indicating at least a first portion of the first set of parameters associated with the SMD MLD and at least a second portion of a second set of parameters associated with the AP device.

Aspect 22: The method of aspect 21, where receiving the indication of the one or more AP devices includes: receiving, via a broadcast address, the message including at least the first portion of the first set of parameters and at least the second portion of the second set of parameters.

Aspect 23: The method of any of aspects 20 through 22, where the request for information associated with the AP device includes an identifier of the AP device, a transmitter address of the AP, a basic service set identifier associated with the AP device, a basic service set color associated with a basic service set of the AP device, or any combination thereof.

Aspect 24: The method of any of aspects 19 through 23, where the one or more roaming capabilities of the SMD MLD include a backhaul capability of the SMD MLD.

Aspect 25: The method of any of aspects 19 through 24, where receiving the indication of the first set of parameters includes: receiving a management frame, a beacon signal, a probe request, a probe response, an associated request, a reassociation request, or a response frame, a multi-link reconfiguration message, a basic service set transition management message, or any combination thereof, including the indication of the first set of parameters associated with the SMD MLD.

Aspect 26: The method of any of aspects 19 through 25, where receiving the indication of the first set of parameters includes: receiving an indication of a profile for each AP device of the one or more AP devices affiliated with the SMD MLD.

Aspect 27: The method of aspect 26, where a profile for an AP device of the one or more AP devices affiliated with the SMD MLD includes a Media Access Control address associated with the AP device, an identifier associated with the AP device, one or more AP MLD identifiers, one or more link identifiers of links established with the AP device, a service set identifier associated with the SMD MLD, or any combination thereof.

Aspect 28: The method of aspect 27, where the identifier associated with the AP device is assigned by an MLD AP device, by the SMD MLD, or by a centralized controller.

Aspect 29: The method of any of aspects 19 through 28, where transmitting the indication of the one or more AP devices includes: receiving a reduced neighbor report element, neighbor report element, or a multi-link element, or any combination thereof, including the indication of the one or more APs affiliated with the SMD MLD.

Aspect 30: The method of any of aspects 19 through 29, where the indication of the one or more AP devices includes a basic service set parameters subfield and an MLD parameters subfield for each AP device of the one or more AP devices.

Aspect 31: A first device for wireless communications, including a processing system that includes processor circuitry and memory circuitry that stores code, the processing system configured to cause the first device to perform a method of any of aspects 1 through 18.

Aspect 32: A first device for wireless communications, including at least one means for performing a method of any of aspects 1 through 18.

Aspect 33: A non-transitory computer-readable medium storing code for wireless communications, the code including instructions executable by a processor to perform a method of any of aspects 1 through 18.

Aspect 34: A second device for wireless communications, including a processing system that includes processor circuitry and memory circuitry that stores code, the processing system configured to cause the second device to perform a method of any of aspects 19 through 30.

Aspect 35: A second device for wireless communications, including at least one means for performing a method of any of aspects 19 through 30.

Aspect 36: A non-transitory computer-readable medium storing code for wireless communications, the code including instructions executable by a processor to perform a method of any of aspects 19 through 30.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,” or “based at least in part on ‘a,” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first device, comprising:
a processing system that includes processor circuitry and memory circuitry that stores code, the processing system configured to cause the first device to:
transmit an indication of a first set of parameters associated with a single mobility domain (SMD) multi-link device (MLD), wherein the first set of parameters comprises at least an identifier of the SMD MLD and one or more roaming capabilities of the SMD MLD;
transmit an indication of one or more access point (AP) devices affiliated with the SMD MLD for which roaming of a wireless station is supported without reassociation; and
facilitate a transfer of context information for the wireless station from a first AP device of the one or more AP devices to a second AP device of the one or more AP devices in accordance with the roaming.

2. The first device of claim 1, wherein the processing system is further configured to cause the first device to:
receive a request for information associated with an AP device of the one or more AP devices based at least in part on transmitting the indication of the one or more AP devices.

3. The first device of claim 2, wherein the processing system is further configured to cause the first device to:
transmit, in response to the request for information associated with the AP device, a message indicating at least a first portion of the first set of parameters associated with the SMD MLD and at least a second portion of a second set of parameters associated with the AP device.

4. The first device of claim 3, wherein, to transmit the indication of the one or more AP devices, the processing system is configured to cause the first device to:
transmit, to a broadcast address, the message comprising at least the first portion of the first set of parameters and at least the second portion of the second set of parameters.

5. The first device of claim 3, wherein the second set of parameters comprises one or more link identifiers of links established with the AP device an identifier of the AP device, a Medium Access Control (MAC) address of the AP device, or any combination thereof.

6. The first device of claim 2, wherein the request for information associated with the AP device comprises an identifier of the AP device, a transmitter address of the AP device, a basic service set identifier associated with the AP device, a basic service set color associated with a basic service set of the AP device, or any combination thereof.

7. The first device of claim 2, wherein the request corresponds to all AP devices of the one or more AP devices or a subset of AP devices of the one or more AP devices.

8. The first device of claim 1, wherein the one or more roaming capabilities of the SMD MLD include a backhaul capability of the SMD MLD.

9. The first device of claim 1, wherein, to transmit the indication of the first set of parameters, the processing system is configured to cause the first device to:
transmit a management frame, a beacon signal, a probe request, a probe response, an associated request, a reassociation request, or a response frame, a multi-link reconfiguration message, a basic service set transition management message, or any combination thereof, comprising the indication of the first set of parameters associated with the SMD MLD.

10. The first device of claim 1, wherein, to transmit the indication of the first set of parameters, the processing system is configured to cause the first device to:
transmit an indication of a profile for each AP device of the one or more AP devices affiliated with the SMD MLD.

11. The first device of claim 10, wherein a profile for an AP device of the one or more AP devices affiliated with the SMD MLD comprises a Media Access Control address associated with the AP device, an identifier associated with the AP device, one or more AP MLD identifiers, one or more link identifiers of links established with the AP device, a service set identifier associated with the SMD MLD, or any combination thereof.

12. The first device of claim 11, wherein the processing system is further configured to cause the first device to:
receive, from the AP device, an indication of the one or more link identifiers of the links established by the AP device.

13. The first device of claim 1, wherein, to transmit the indication of the one or more AP devices, the processing system is configured to cause the first device to:
transmit a reduced neighbor report element, a neighbor report element, or a multi-link element, or any combination thereof, comprising the indication of the one or more AP devices affiliated with the SMD MLD.

14. The first device of claim 1, wherein the indication of the one or more AP devices comprises a basic service set parameters subfield and an MLD parameters subfield for each AP device of the one or more AP devices.

15. The first device of claim 1, wherein the indication of the one or more AP devices indicates whether each AP device of the one or more AP devices is an MLD AP or a non-MLD AP.

16. The first device of claim 1, wherein the context information comprises one or more encryption keys associated with the wireless station, one or more pseudorandom numbers associated with the wireless station, one or more sequence numbers associated with the wireless station, one or more block acknowledgments associated with the wireless station, or any combination thereof.

17. A second device, comprising:
a processing system that includes processor circuitry and memory circuitry that stores code, the processing system configured to cause the second device to:
receive an indication of a first set of parameters associated with a single mobility domain (SMD) multi-link device (MLD), wherein the first set of parameters comprises at least an identifier of the SMD MLD and one or more roaming capabilities of the SMD MLD;
receive an indication of one or more access point (AP) devices affiliated with the SMD MLD for which roaming of a wireless station is supported without reassociation; and
facilitate a transfer of context information for the wireless station from a first AP of the one or more AP devices to a second AP device of the one or more AP devices in accordance with the roaming.

18. The second device of claim 17, wherein the processing system is further configured to cause the second device to:
transmit a request for information associated with an AP device of the one or more AP devices based at least in part on transmitting the indication of the one or more AP devices.

19. The second device of claim 18, wherein the processing system is further configured to cause the second device to:
receive, in response to the request for information associated with the AP device, a message indicating at least a first portion of the first set of parameters associated with the SMD MLD and at least a second portion of a second set of parameters associated with the AP device.

20. The second device of claim 19, wherein, to receive the indication of the one or more AP devices, the processing system is configured to cause the second device to:
receive, via a broadcast address, the message comprising at least the first portion of the first set of parameters and at least the second portion of the second set of parameters.

21. The second device of claim 18, wherein the request for information associated with the AP device comprises an identifier of the AP device, a transmitter address of the AP device, a basic service set identifier associated with the AP device, a basic service set color associated with a basic service set of the AP device, or any combination thereof.

22. The second device of claim 17, wherein the one or more roaming capabilities of the SMD MLD include a backhaul capability of the SMD MLD.

23. The second device of claim 17, wherein, to receive the indication of the first set of parameters, the processing system is configured to cause the second device to:
receive a management frame, a beacon signal, a probe request, a probe response, an associated request, a reassociation request, or a response frame, a multi-link reconfiguration message, a basic service set transition management message, or any combination thereof, comprising the indication of the first set of parameters associated with the SMD MLD.

24. The second device of claim 17, wherein the indication of the one or more AP devices comprises a basic service set parameters subfield and an MLD parameters subfield for each AP device of the one or more AP devices.

25. A method for wireless communications at a first device, comprising:
transmitting an indication of a first set of parameters associated with a single mobility domain (SMD) multi-link device (MLD), wherein the first set of parameters comprises at least an identifier of the SMD MLD and one or more roaming capabilities of the SMD MLD;
transmitting an indication of one or more access point (AP) devices affiliated with the SMD MLD for which roaming of a wireless station is supported without reassociation; and
facilitating a transfer of context information for the wireless station from a first AP device of the one or more AP devices to a second AP device of the one or more AP devices in accordance with the roaming.

26. The method of claim 25, wherein the one or more roaming capabilities of the SMD MLD include a backhaul capability of the SMD MLD.

27. The method of claim 25, wherein transmitting the indication of the one or more AP devices comprises:
transmitting a reduced neighbor report element, a neighbor report element, or a multi-link element, or any combination thereof, comprising the indication of the one or more AP devices affiliated with the SMD MLD.

28. A method for wireless communications at a second device, comprising:
receiving an indication of a first set of parameters associated with a single mobility domain (SMD) multi-link device (MLD), wherein the first set of parameters comprises at least an identifier of the SMD MLD and one or more roaming capabilities of the SMD MLD;
receiving an indication of one or more access point (AP) devices affiliated with the SMD MLD for which roaming of a wireless station is supported without reassociation; and
facilitating a transfer of context information for the wireless station from a first AP of the one or more AP devices to a second AP device of the one or more AP devices in accordance with the roaming.

29. The method of claim 28, wherein receiving the indication of the first set of parameters comprises:
receiving a management frame, a beacon signal, a probe request, a probe response, an associated request, a reassociation request, or a response frame, a multi-link reconfiguration message, a basic service set transition management message, or any combination thereof, comprising the indication of the first set of parameters associated with the SMD MLD.

30. The method of claim 28, wherein receiving the indication of the first set of parameters comprises:
receiving an indication of a profile for each AP device of the one or more AP devices affiliated with the SMD MLD.
